(19) United States
(12) Patent Application Publication
(10) Pub. No.: US 2009/0218997 A1
(43) Pub. Date: Sep. 3, 2009

(54) POWER SUPPLY CIRCUIT

(76) Inventors: George M. Hey, San Jose, CA (US); John Chiang-Yung Lee, Palo Alto, CA (US); Richard A. O'Brien, Livermore, CA (US)

Correspondence Address: BRINKS HOFER GILSON & LIONE, P.O. BOX 10395, CHICAGO, IL, 60610, US

(21) Appl. No.: 12/040,397

(22) Filed: Feb. 29, 2008

(51) Int. Cl. G05F 1/10

(52) U.S. Cl. 323/273

(57) ABSTRACT

In one embodiment, a current limiter is configured to limit current drawn from a main power supply to a maximum value. A load device is coupled with an output of the current limiter. The load device is configured to periodically draw a first current during operation. The maximum value is below a value of the first current. A charge storage device is coupled with the load device. The charge storage device is configured to supply additional current to the load device to satisfy the first current value. A linear voltage regulator is coupled between the charge storage device and the load device.

### BACKGROUND

The present disclosure relates generally to power management.

Many devices require electrical power to operate. For example, data communication devices use supply voltage or current to perform desired functions, such as processing, transmitting, and/or receiving data. Some power systems, subsystems, or devices may be sized for peak power demand.

However, such systems or devices may involve larger power supplies that may require heavier or larger current carrying conductors for power delivery. Larger conductors may increase cost as well as size of devices. Other systems or devices, such as data communication systems or devices, may not receive sufficient power or prevent a component from using peak power. Such techniques may adversely impact quality and/or range of communications.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates a data communication system;

FIG. 2 illustrates a device that may be used in a system, such as the system of FIG. 1;

FIG. 3 illustrates a power supply circuit that may be used with the device of FIG. 2;

FIG. 4 illustrates a current pattern over time;

FIG. 5 illustrates a method for supplying power; and

FIG. 6 illustrates a method for providing a power supply circuit.

### DESCRIPTION OF EXAMPLE EMBODIMENTS

### Overview

By way of introduction, the example embodiments described below include a power supply circuit and associated methods. For example, the power supply circuit is used in conjunction with a load device, such as a data communication device. The power supply circuit may limit current from a main power supply below a desired current and still provide a peak power to the load device.

According to a first aspect, a current limiter is configured to limit current drawn from a main power supply to a maximum value. A load device is coupled with an output of the current limiter. The load device is configured to periodically draw a first current during operation. The maximum value is below a value of the first current. A capacitor or alternate charge storage device is coupled with the load device. The charge storage device is configured to supply additional current to the load device to satisfy the first current value. A linear voltage regulator is coupled between the charge storage device and the load device.

According to a second aspect, a current limiter has an input and an output. The input of the current limiter is configured to couple with a main power supply. A diode is coupled with the input of the current limiter. A capacitor is coupled with the output of the current limiter. A low dropout voltage regulator is coupled with the capacitor and the output of the current limiter. An output of the low dropout voltage regulator is configured to supply a substantially noise free power to a load device.

According to a third aspect, a host device is provided. A plurality of modules are configured to couple with the host device. Each of the plurality of modules includes a current limiter configured to limit power from the host device. A data communication device is coupled with an output of the current limiter. The data communication device is configured to periodically draw a first power. A capacitor is coupled with the data communication device. The capacitor is configured to store power from the host device and supplement the current limiter to satisfy a value of the first power. A linear voltage regulator is coupled between the capacitor and the data communication device. The linear voltage regulator is configured to step down a voltage.

According to a fourth aspect, a load device is operated. The load device periodically draws a first current during operation. A current drawn from a main power source is limited to a limited current value. The limited current value is below a value of the first current. Additional current from a capacitor is supplied to satisfy a desired current during the operation of the load device. Also, a substantially constant and substantially noise free voltage is supplied to the load device.

According to a fifth aspect, a current limiter having an input and an output is provided. The input of the current limiter is configured to couple with a main power supply. A capacitor is coupled with the output of the current limiter. A linear voltage regulator is coupled with the capacitor and the output of the current limiter. A load device is coupled with an output the linear voltage regulator. The output of the linear voltage regulator is configured to provide a supply power to the load device.

The present invention is defined by the following claims, and nothing in this section should be taken as a limitation on those claims. Further aspects and advantages of the invention are discussed below in conjunction with the preferred embodiments.

### Example Embodiments

Data communication devices, such as a GSM-based wireless modem, present a time varying bursty power load during operation. For example, GSM power consumption includes heavy power bursts lasting one or more milliseconds in duration, such as during transmission, and significantly less power consumption otherwise, such as during a receiving mode. A power supply circuit is used to limit current from a main power supply during the heavy power bursts, which allows for smaller or lighter cabling, wiring, and/or connections. For example, power connections to a plurality of data communication devices within a host device, such as a router, may be reduced in size and/or ratings by the power supply circuit. Even though current from a main power source is limited, the power supply circuit is able to provide a desired current or power to the data communication device for operation, including during peak power demand periods.

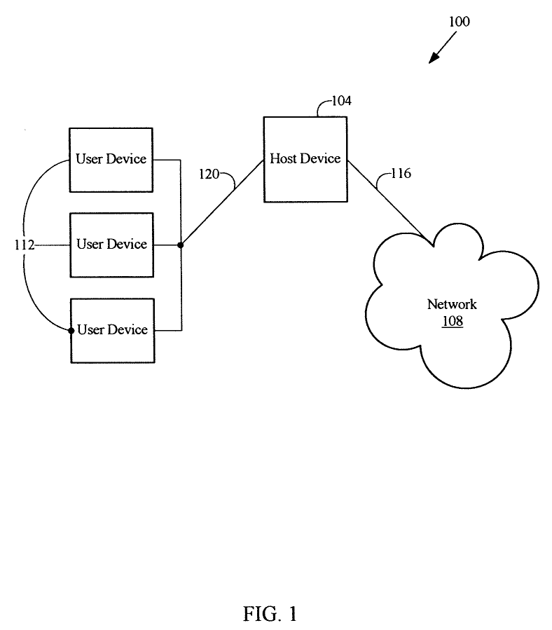

FIG. 1 shows a data communication system 100 (hereinafter referred to as “system 100”). The system 100 is an Internet protocol-based system, an Intranet system, a telephony system, a cellular based system, a wireless or wired audio/visual data communication system, and/or any known or future data communication system.

The system 100 includes, but is not limited to, a host device 104, a network 108, and user devices 112. Additional, different, or fewer devices or components may be provided. For example, a proxy server, a billing server, a name server, a switch or intelligent switch, a computer or workstation, administrative components, such as an administrative workstation, a gateway device, a backbone, ports, network connections, and network interfaces may be provided. While the components in FIG. 1 are shown as separate from one another, one or more of these components may be combined.

The host device 104 is a router, server, laptop computer, desktop computer, switch, workstation, or other data communication device. For example, the host device 104 is a router configured to connect with the network 108 via a connection 116. The connection 116 is a wireless or wired connection. For example, the host device 104 is a GSM based router that wirelessly communicates with the network 108. Other wireless communications, such as wideband code division multiple access (“WCDMA”), code division multiple access (“CDMA”), or Bluetooth, may be used.

The network 108 is the Internet, cellular network, an intranet, a local area network (“LAN”), a wide area network (“WAN”), a virtual private network (“VPN”), and/or any known or future network. The network may contain cellular basestations, servers, computers, or other systems, devices, or components for transferring and/or modifying data.

The host device 104 also communicates with the user devices 112 via a connection 120. The connection 120 is a wired connection including cables, conductors, or other wiring. Alternatively, the connection 120 is a wireless connection or a network. The user devices 112 are workstations, phones, desktop or laptop computers, personal digital assistants (“PDAs”), processing devices, and/or other data communication devices that can be operated by a user. A user uses the user devices 112 to view websites or other digital forums, view messages, check email, initiate or receive phone calls, access the Internet, intranet, or other networks, and/or perform any other data processing. For example, the user devices 112 are adapted to receive and transmit 2G or 3G global system for mobile communications (“GSM”) communications. Other communication standards may be used. Alternatively, the user devices 112 may be intermediate devices, such as servers or switches, that communicate with user devices. Also, the host device 104 may be part of the user devices 112 or may be a separate user device.

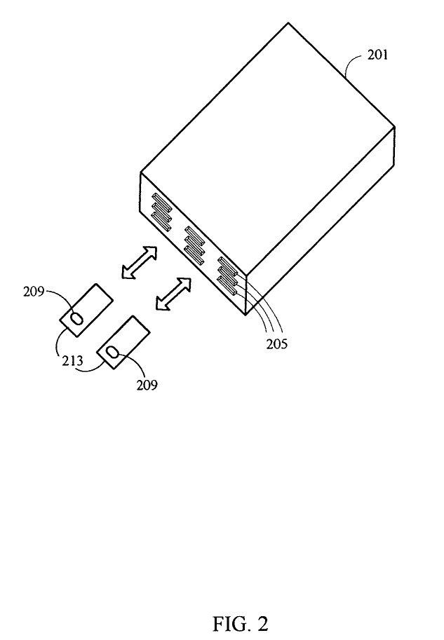

FIG. 2 shows a host device 201, such as the host device 104. For example, the host device 201 is a router, such as the Cisco 1841, 2800, or 3800 series integrated service router provided by Cisco, Inc of San Jose, Calif. The host device 201 includes ports or slots 205 (hereinafter referred to as “slots”) and a housing. The host device may have a substantially rectangular housing with a relatively smaller height compared to the length and width. Alternatively, the housing may have other geometrical shapes.

The slots 205 are used to receive modules or data cards 213 (hereinafter referred to as “modules”). The slots 205 are located in a front, back, side, or inside of the host device 201. The slots 205 receive the modules 213 and connect the modules 213 with a main power supply and processing circuitry of the host device 201. The host device 201 may include one or more slots 205. For example, the host device 201 includes at least about 3 slots 205.

The modules 213 are or include PC or PCI cards, wireless data cards, integrated circuit cards, subscriber identity modules (“SIMs”), modems, or other data devices that connect with a host device. For example, the modules 213 are GSM wireless data modules, such as high speed wide area network (“WAN”) interface cards provided by Cisco, Inc. of San Jose, Calif. incorporating 3G Wireless mini peripheral component interconnect (“PCI”) express cards. Each module 213 is supplied with power from a main power supply of the host device 201. For example, the host device 201 of one embodiment plugs into or receives power from a standard 110 VAC wall outlet or power supply. Other power sources may be used. The host device 201 converts the 110 VAC power to a lower voltage, such as a lower DC voltage to power each of the modules 213 and/or other circuitry. For example, cables, wiring, connections, and/or other conductors supply a converted voltage, such as 5 VDC, to each of the modules 213.

Each of the modules 213 includes one or more components 209. For example, the components 209 are embedded antennas, trace antennas, protruding antennas, and/or other antennas used to transmit and/or receive signals or data for each of the modules 213. Separate antennas may be used between receive and transmit operations. Alternatively, the components 209 are antenna ports or connections that connect with respective antennas within or on the host device 201. Different antennas and/or antenna connections may correspond to different modules 213. Alternatively, multiple modules 213 may use or connect with a common antenna.

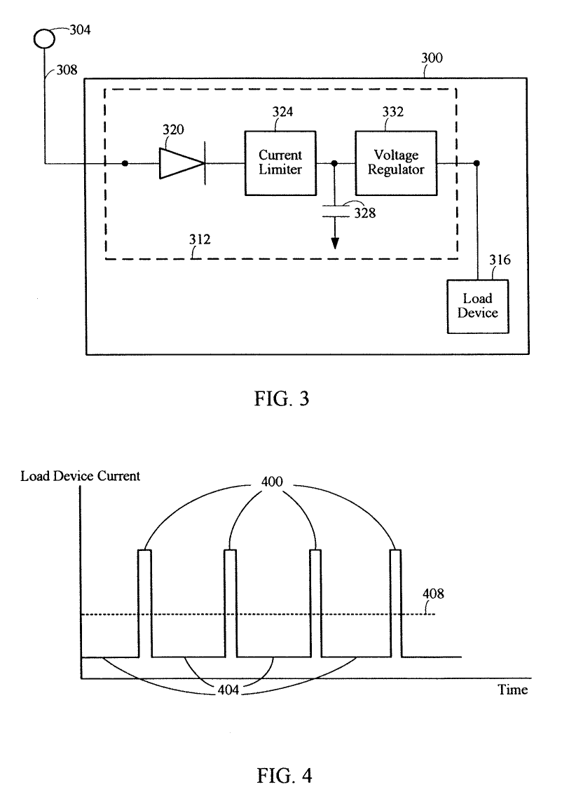

FIG. 3 is a circuit diagram of a module 300, such as one of the modules 213. The module 300 includes a power supply circuit 312 (hereinafter referred to as “circuit 312”) and a load device 316. Fewer, more, or different components may be provided. For example, the module 300 may include a SIM card holder or circuitry, an antenna, an antenna connection or port, one or more processors, such as a general processor, application-specific integrated circuit (“ASIC”), digital signal processor, field programmable gate array (“FPGA”), digital circuit, analog circuit, or combinations thereof, one or more memories, and/or other circuitry or components. Different components may be integrated or remain separate.

A main power supply, source, or output 304 connects with the circuit 312 via a connection 308. Power is provided to the load device 316 from the main power supply via the circuit 312. For example, the main power supply 304 provides 5 VDC power to the module 300 and other devices or components of an associated host device, such as the host device 104 or 201. The connection 308 is a wire, trace, connector, or other conductor. Power or current via 308 allocated to module 300 is limited according to a system power budget and/or according to current ratings of conductors delivering the power. For example, the connection 308 may be rated at about 1 Ampere.

The load device 316 is a modem, processor, data communication device, or other device that periodically draws different power levels during operation. The load device 316 of one embodiment may be a low voltage digital component or integrated circuit and/or an analog component or circuit. For example, the load device 316 may be a wireless GSM modem operating from a 3.3 VDC power source. The load device intermittently or periodically requires, pulls, uses, or draws peak power or current during its operation. Peak or a higher current is drawn during these operation intervals in order to support the peak power demand. For example, higher peak power bursts or pulses may draw a higher current during transmission modes of the load device compared to that of receive or other modes.

FIG. 4 shows a current pattern over time that corresponds to the power consumption or current draw of the load device 316. High power or current intervals, periods, or bursts 400 are periodically repeated during operation of the load device 316. Each of the high power bursts may have a duration of at least about one millisecond. For example, a duty cycle of the peak demand is typically less than about 20% of the total combined peak and non-peak periods. Therefore, an average current or power 408 is less than the peak current or power of the high power bursts 400. Alternatively, the high power bursts 400 may have shorter or longer duration timings. During these periods, a higher current, such as 2.5 A, is desired by the load device 316 to operate at a peak capacity. For example, the high power or current periods correspond to transmission of data or a transmit processing. During intermediate intervals or periods 404, the load device 316 uses less power or current. The intermediate intervals or periods 404 may correspond to receive operations or other modes. The high power bursts 400 and the intermediate intervals or periods 404 may have a constant or varying periodic pattern during operation of the load device 316.

Referring back to FIG. 3, the circuit 312 is used to provide an ample, sufficient, or desired amount of power or current to the load device 316 for operation as well as limit current drawn from the main power supply 304. The circuit 312 includes a diode 320, a current limiter 324, a capacitor 328, and a voltage regulator 332. Fewer, more, or different components may be provided. Less, at, or more than the peak desired power may be provided.

The anode of the diode 320 couples with the connection 308, and the cathode of the diode 320 couples with the current limiter 324. An output of the current limiter 324 couples with the capacitor 328. The other end of the capacitor 328 is coupled with a ground or other return path. The connection point of the capacitor 328 and the output of the current limiter 324 is also coupled with an input to the voltage regulator 332. An output of the voltage regulator 332 is coupled with the load device 316. The connections of the components may be made using traces, such as copper, gold, silver, or other elements, vias, or other conductors. The components of the circuit 312 may be discrete components or integrated components.

The diode 320 is a Schottky diode, other type of diode, or another device configured to pass current in a forward direction and block current in a reverse direction. For example, the diode 320 is a Schottky diode. The diode 320 allows current to pass from the main power supply 304 to other components. The diode 320 also acts as a protection device to prevent or prohibit reverse current from flowing from other components, such as the capacitor 328, to the main power supply 304. The diode 320 of one embodiment may provide a voltage drop of about 0.3 volts or more.

The current limiter 324 may be a fixed or configurable current limiter. For example, the current limiter 324 is a configurable current limiter integrated circuit (“IC”), such as the MIC2544 from Micrel Semiconductor, Inc. of San Jose, Calif. The current limiter 324 allows a maximum current to be drawn into its input. The value of the maximum limited current is less than or below a desired maximum current value according to the allocated budget for module 300 for operation of the load device 316. For example, the current limiter 324 is set to limit the current from the main power supply to at most about 1 A. Because of the maximum current value, the load device 316 may draw at most about 5 Watts average power from the main power source 304. Other maximum current values or powers may be set. The current limiter 324 may be configured before or during manufacturing or by a user during operation of the module 300 or load device 316. For example, the current limiter 324 may be programmed or set on an assembly line and/or by a user via a computer or processor commands.

The capacitor or charge storage device 328 (hereinafter referred to as the “capacitor 328”) may be a metal-insulator-metal (“MIM”) capacitor, ceramic capacitor, a tantalum capacitor, a discrete capacitor, other capacitor, a rechargeable battery, and/or another device operable to hold and supply a charge or current. For example, the capacitor 328 is a 33 milliFarad (“mF”) capacitor, such as the BZ055A from AVX Corp. of Myrtle Beach, S.C. Alternatively, other capacitance values may be used. The capacitor 328 charges up during low power demand periods, such as during the intermediate intervals 404 of the load device 316, and provides reservoir power or current during periods of heavy power consumption, such as during the peak or high power intervals 400 of the load device 316.

The capacitor 328 has a low equivalent series resistance (“ESR”) and a size compatible with spacing and arrangement on or in the circuit 312 and/or module 300. The capacitor 328 has a large capacitance so that it can supply adequate current during the high power bursts 400. For example, the capacitor 328 of one embodiment provides at least about 1.5 A during the high power intervals 400 of the load device 316. Therefore, during the high power intervals 400, the current limiter 324, which provides a limited maximum current, and the capacitor 328, in combination, supply an adequate, sufficient, or desired amount of power or current to the load device 316, such as 2.5 Amperes. The adequate or sufficient amount of power or current may be more, less, or at the desired power or current.

The voltage regulator 332 is a linear regulator, a low dropout (“LDO”) regulator, or other voltage regulator that provides a substantially noise or jitter free output. For example, the voltage regulator 332 is a LDO regulator that can respond quickly to changing load current demands while receiving power from the current limiter 324 and the capacitor 328. The voltage regulator 332 steps down the voltage at the input to a lower voltage used to operate the load device 316. For example, the voltage regulator 332 converts at least about 5 VDC to about 3.3 VDC. By using at least about 5 VDC, the main power supply 304 is able to provide a range of voltages to various components of the module 300. Also, because the load device 316 is powered at about 3.3 VDC, a higher voltage from the main power supply 304, such as 5 VDC, is beneficial because other components, such as the diode 320, can be used even though they generate voltage drops.

The voltage regulator 332 maintains a substantially constant and noise free output voltage even though the input voltage may vary. Using a linear voltage regulator allows for a substantially noise free output signal, which is beneficial in transmission or reception operations, such as operations by transceivers. On the other hand, a switching power supply or boost converter may not provide a relatively noise free output, which may impact the performance of the load device 316.

In operation, the circuit 312 limits current from the main power supply 304. The current from the main power supply 304 is below a desired current that the load device 316 uses during high power bursts 400. However, the capacitor 328 supplies additional current to the load device 316 during the high power bursts to satisfy the desired current and compensate for the limited current. This may allow for ideal or peak operation of the load device 316 as well as a reduced size and/or rating of the main power supply connections, such as the connection 308. The reduced size or ratings of the connections decreases cost and helps in reducing size of a host device, such as the host device 104 and 201, especially when a plurality of modules 300 are connected with the host device. Also, power is conserved from the main power supply 304.

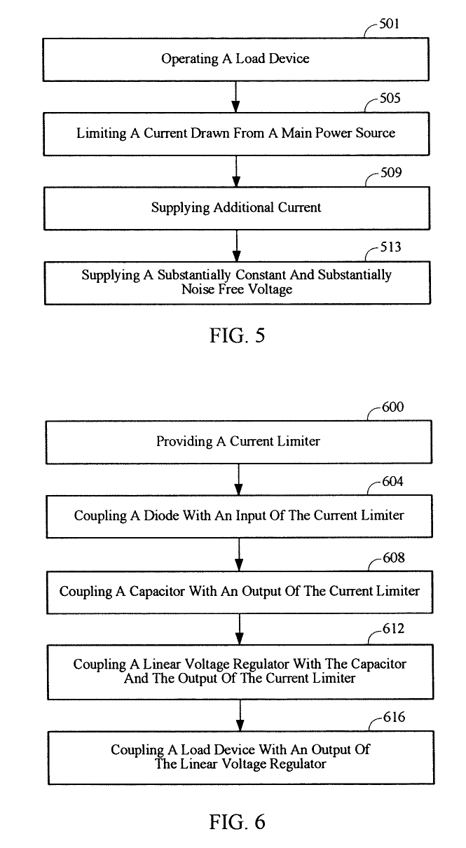

FIG. 5 shows an exemplary method for supplying power. Fewer or more acts may be provided. In act 501, a load device, such as the load device 316, is enabled or operated. For example, one or more modules, such as the modules 213 or 300, are placed in a host device, such as the host device 104 or 201. The host device is turned on for communications. For example, a wireless router connected with a site network, system, and/or devices wirelessly transmits and receives data from an external network, such as the network 108. The host device supplies power to the module(s). The load devices periodically pull more power or current in high power bursts or intervals, such as the high power bursts 400. For example, during transmission processing, the load devices may desire at least 2.5 A for at least one or more millisecond power bursts. The current for the high power bursts allows the load devices to transmit in a maximum range or allows for a higher quality transmission.

In act 505, a current or power from a power supply of the host device, such as the main power supply 304, is limited. For example, current drawn by module 300 during a high or peak power interval from the host power supply 304 is limited. A current limiter, such as the current limiter 324, may be used. A maximum current limit value is set prior to operation of the load device. Alternatively, the maximum current limit value may be set or changed during operation by a user or by a dynamic set of logic. For example, a feedback circuit, sensors, or other indicators may be used to dynamically change the maximum current limit. A maximum current limit value may be set to at most about 1 A. Other current values may be used.

In act 509, supplemental power or current is supplied to the load device. During intermediate intervals 404, load device current demand is less than the current limiter's available 1 Ampere capacity. During these intermediate periods 404, a capacitor, such as the capacitor 328, is recharged using remaining available current from the current limiter. For example, during intermediate intervals 404, the load device may be supplied with current drawn solely from the power supply of the host device. The capacitor provides supplemental current to voltage regulator 332 for delivery to the load device during high or peak power load bursts. During high or peak power bursts, such as the intervals 400, supplemental current from the capacitor combined with the limited current satisfies or provides a desired, adequate, or ample amount of current or power to the load device. Without the supplemental current, the load device may have to operate at less than optimum level because the limited current value is below a desired current value for operation during the high power intervals. The supplemental current may be at least about 1.5 A in one embodiment. Alternatively, other additional current values may be used. The additional current or charge may be prevented from flowing to the power supply of the host device. For example, a diode, such as the diode 320, may be used to prohibit reverse current.

In act 513, a substantially constant and substantially noise free voltage is supplied to the load device. For example, a substantially constant and noise free voltage is applied to the load device while current varies between low and high power intervals. The substantially constant and noise free voltage is a stepped down voltage from the power supply of the host device. For example, 5 VDC of the host power supply is converted to about 3.3 VDC. A voltage regulator, such as the voltage regulator 332, may be used to provide the substantially constant and noise free voltage. Reduction of noise in the supply power may benefit the operation of the load device, such as allow for better quality in modem operations.

FIG. 6 is a method for manufacturing or providing a power supply circuit. Fewer or more acts may be provided. In act 600, a current limiter, such as the current limiter 324, is provided. The current limiter may be attached or soldered on a printed circuit board associated with a module, such as the module 213 or 300. For example, the printed circuit board is an integral part of the module or may be attachable and removable from the module. The current limiter is configured to attach with a main power supply, such as the main power supply 304.

In act 604, a diode, such as the diode 320, is connected with an input of the current limiter. For example, the cathode of the diode is connected with the input of the current limiter, and the anode of the diode is configured to connect with the main power supply or connections thereof. Alternatively, the diode may be connected at the output of the current limiter before a capacitor connection. A capacitor, such as the capacitor 328, is connected with an output of the current limiter, in act 608. The other end of the capacitor is connected with a ground or other return path connection.

In act 612, the output of the current limiter and the end of the capacitor connected with the output of the current limiter are connected with an input of a linear voltage regulator, such as the voltage regulator 332. In act 616, an output of the linear voltage regulator is connected with a load device, such as the load device 316.

The connections made between the components may be made by soldering, printing, etching, or other manufacturing processes. The order of connections may be changed to produce a similar circuit. Various components may be placed on different sides or inner layers of a circuit board.

The logic, software or instructions for implementing the processes, methods and/or techniques discussed above are provided on computer-readable storage media or memories or other tangible media, such as a cache, buffer, RAM, removable media, hard drive, other computer readable storage media, or any other tangible media. The tangible media include various types of volatile and nonvolatile storage media. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”) or system.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A circuit comprising:
a current limiter configured to limit current drawn from a main power supply to a maximum value;
a load device coupled with an output of the current limiter, the load device configured to periodically draw a first current during operation, wherein the maximum value is below a value of the first current;
a charge storage device coupled with the load device, the charge storage device configured to supply additional current to the load device to satisfy the first current value; and
a linear voltage regulator coupled between the charge storage device and the load device.

2. The circuit of claim 1, wherein the load device is configured to periodically draw a second current between the periodic drawing of the first current, and wherein the first current value is higher than a value of the second current.

3. The circuit of claim 1, wherein the first current corresponds to intermittent high power intervals, each of the high power intervals having a duration of at least about one millisecond.

4. The circuit of claim 3, wherein each of the high power intervals corresponds to a transmission of data.

5. The circuit of claim 1, wherein the load device comprises a modem.

6. The circuit of claim 1, wherein the maximum value is at most about 1 Amperes.

7. The circuit of claim 1, wherein the additional current is at least about 1.5 Amperes.

8. A circuit comprising:
a current limiter having an input and an output, the input of the current limiter configured to couple with a main power supply;
a diode coupled with the input of the current limiter;
a capacitor coupled with the output of the current limiter; and
a low dropout voltage regulator coupled with the capacitor and the output of the current limiter,
wherein an output of the low dropout voltage regulator is configured to supply a substantially noise free power to a load device.

9. The circuit of claim 8, wherein a current limit value of the current limiter is variable.

10. The circuit of claim 8, wherein an output voltage of the low dropout voltage regulator is about 3.3 direct current volts, and wherein a voltage provided by the main power supply is at least about 5 direct current volts.

11. The circuit of claim 8, wherein the capacitor is configured to supply additional current to compensate for a limited current set by the current limiter.

12. The circuit of claim 8, wherein the capacitor has a capacitance of at least about 33 milliFarads.

13. The circuit of claim 8, wherein the diode comprises a Schottky diode.

14. An apparatus comprising:
a host device;
a plurality of modules configured to couple with the host device, each of the plurality of modules comprising:
a current limiter configured to limit power from the host device;
a data communication device coupled with an output of the current limiter, the data communication device configured to periodically draw a first power;
a capacitor coupled with the data communication device, the capacitor configured to store power from the host device and supplement the current limiter to satisfy a value of the first power; and
a linear voltage regulator coupled between the capacitor and the data communication device, the linear voltage regulator configured to step down a voltage.

15. The apparatus of claim 14, wherein the host device comprises a router.

16. The apparatus of claim 14, wherein each of the data communication devices of each of the plurality of modules comprises a wireless GSM modem.

17. A method comprising:
operating a load device, the load device periodically drawing a first current during operation;
limiting a current drawn from a main power source to a limited current value, the limited current value being below a value of the first current;
supplying additional current from a capacitor to satisfy a desired current during the operation of the load device; and
supplying a substantially constant and substantially noise free voltage to the load device.

18. The method of claim 17, wherein the periodic drawing of the first current corresponds to periodic power bursts for transmission of data.

19. The method of claim 18, wherein the load device draws at most about 5 Watts from the main power source during each of the periodic power bursts.

20. A method comprising:
providing a current limiter having an input and an output, the input of the current limiter configured to couple with a main power supply;
coupling a capacitor with the output of the current limiter;
coupling a linear voltage regulator with the capacitor and the output of the current limiter; and
coupling a load device with an output of the linear voltage regulator, the output of the linear voltage regulator configured to provide a supply power to the load device.

21. The method of claim 20, further comprising:
coupling a diode with the input of the current limiter.
